(19) United States
(12) Patent Application Publication
(10) Pub. No.: US 2018/0290910 A1
(43) Pub. Date: Oct. 11, 2018

(54) PORTABLE DEVICE FOR WATER TREATMENT

(71) Applicant: Claude L. Hebert, Boucherville (CA)

(72) Inventor: Claude L. Hebert, Boucherville (CA)

(21) Appl. No.: 15/731,049

(22) Filed: Apr. 11, 2017

(51) Int. Cl. C02F 9/00; C02F 1/00; C02F 1/32; C02F 3/06; C02F 1/48

(52) U.S. Cl. CPC C02F 9/005; C02F 1/006; C02F 1/32; C02F 2003/003; C02F 1/48; C02F 2201/009; C02F 3/06

(57) ABSTRACT

A portable water purifier which includes a housing, an inlet conduit, a first filtration station, a pump for pumping an aqueous fluid through the inlet conduit and through the first filtration station, a second filtration station, a magnetic treatment station wherein the magnetic lines of flux are angled with respect to the flow of water, a UV station, and a discharge conduit.

### FIELD OF THE INVENTION

The present invention relates to a device for purifying water and more particularly, relates to a portable water purifier.

### BACKGROUND OF THE INVENTION

The problem of purifying water exists the world over. Inherently, most available water cannot be used for drinking or other human consumption without going through purification.

For large urban areas, the treatment of water for human use is done at centrally located facilities. The treatment steps are well known in the art and are practised worldwide.

However, outside of urban areas, the treatment of water is far more problematic. While the water can be treated in situations where there are enough residences or demand in a centrally located area, the same is not true in extreme rural areas and particularly so in poor countries. The problem is widespread and there have been solutions proposed. Generally, these solutions include the use of portable water purifiers.

While some portable water purifiers function in a manner to properly treat the water, many do not.

### SUMMARY OF THE INVENTION

It is an object of the present invention to provide a portable water purifier which is designed to treat all different types of polluted water and to present a safe drinkable product at the discharge end of the treatment.

According to one aspect of the present invention, there is provided a portable water purifier comprising a housing, an inlet conduit, a first filtration station, a pump for pumping an aqueous fluid through the inlet conduit and through the first filtration station, a second filtration station, a magnetic treatment station wherein the magnetic lines of flux are angled with respect to the flow of the water, a UV station, and a discharge conduit.

According to a further aspect of the present invention, there is also provided a method for purifying water comprising the steps of passing water to be treated through a first filtration station, pumping the water through a second filtration station, subsequently pumping the water through a magnetic treatment station wherein the magnetic lines of flux are angled with respect to the flow of the water, and subjecting the water to an ultraviolet treatment.

In the above preferred embodiment, the water to be treated goes through a number of steps. Initially, the water is subjected to a physical filtration step to remove physical particles therefrom.

A pump is utilized to direct the water as required. The pump is preferably mounted within the housing and is a DC powered pump.

The water is then subjected to a second filtration operation. The second filtration operation preferably comprises a filtration media formed of KDF® particles. Preferably, the KDF® water filter media are utilized in conjunction with granular activated carbon. The KDF® media protect the carbon bed against contamination by bacterial growth.

The oxidation reduction process operates wherein a combination of copper and zinc particles creates an electro-chemical reaction. During this reaction, electrodes are transferred between molecules and new elements are created. As explained by KDF®, some harmful contaminants are changed into harmless components. Free chlorine is said to be changed into water soluble chloride which is then carried harmlessly through the water. Some heavy metals such as copper, led, mercury and others plate out onto the medium surface and thus are effectively removed from the water supply.

Subsequently, the water is subjected to a magnetic treatment wherein the water is passed spirally around a plurality of magnets such that the lines of flux form an angle with respect to the direction of flow of the water.

Finally, the water is subjected to an ultraviolet treatment, the ultraviolet station preferably being powered by 12 volt DC.

The system preferably includes a rechargeable battery which is powered by a suitable solar panel. Naturally, other arrangements for supplying power could be utilized if such power is locally available.

The systems of the present invention can be utilized in many situations. Thus, when large scale natural disasters happen, water is one of the very first priorities and the system of the present invention allows one to obtain drinkable water locally. Preferably, the system would be housed in a military grade shock resistant non corrosive case. The system can deliver up to 60 gallons per hour. The source of the water may be any lake water, river water, swamp water, wetlands, etc. The flow would preferably be in the range of one gallon per minute.

### BRIEF DESCRIPTION OF THE DRAWINGS

Having thus generally described the invention, reference will be made to the accompanying drawings illustrating embodiments thereof, in which:

FIG. 1 is a schematic view of the water purification device of the present invention;

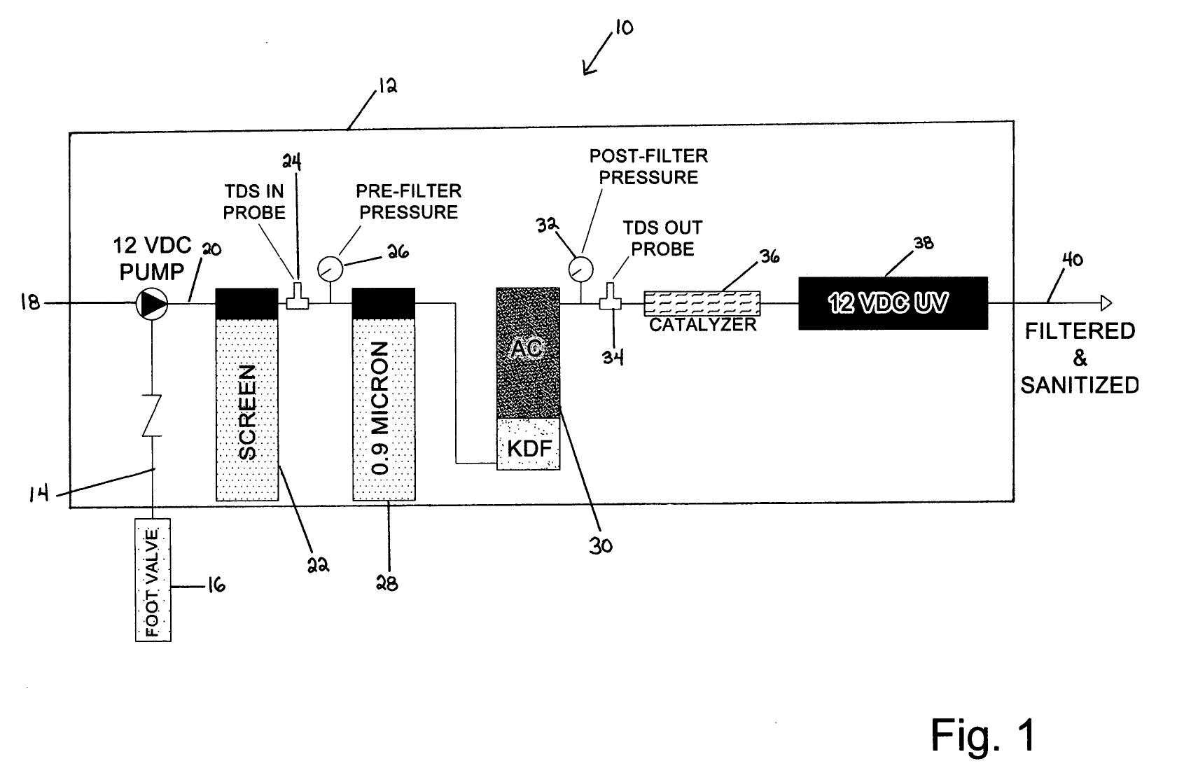

FIG. 2 is a front view of the water purification device;

FIG. 3 is an electrical schematic;

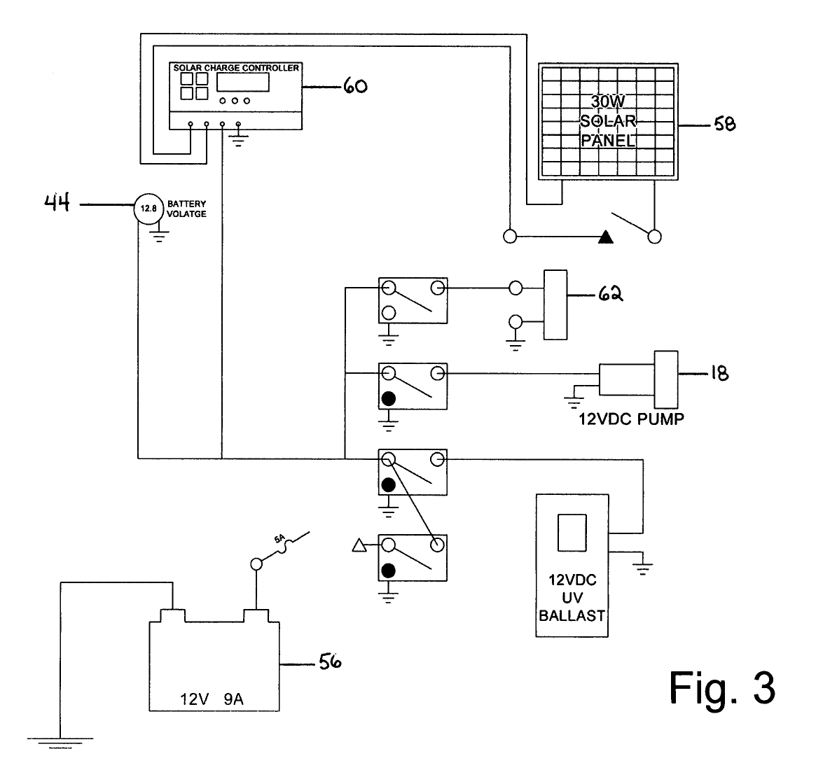

FIG. 4 is a longitudinal sectional view of a portion of the magnetic portion of the water purification device;

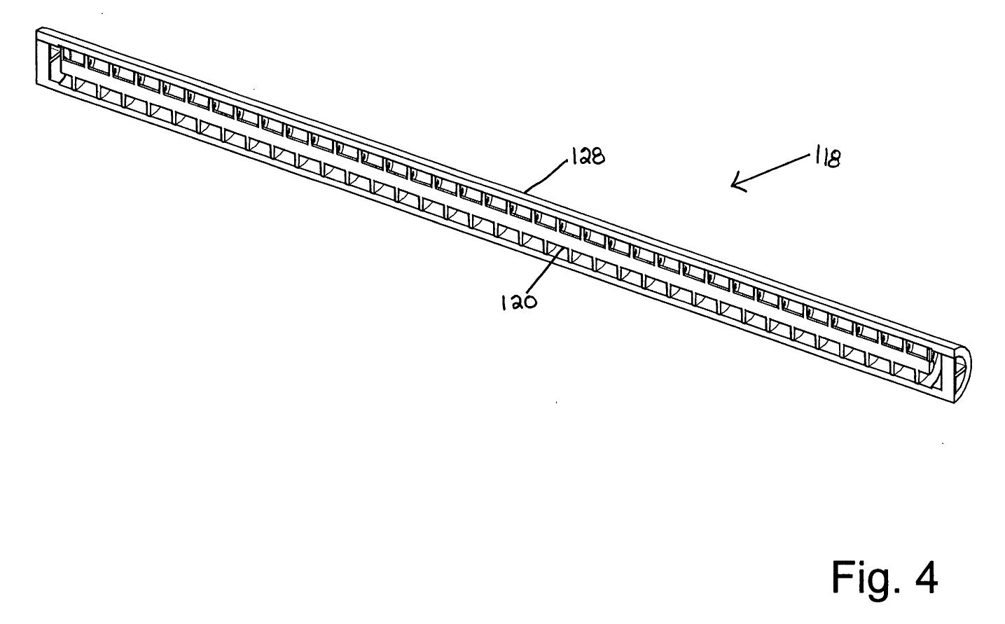

FIG. 5 is a longitudinal sectional view of a cylindrical outer tube with helical flights thereabout;

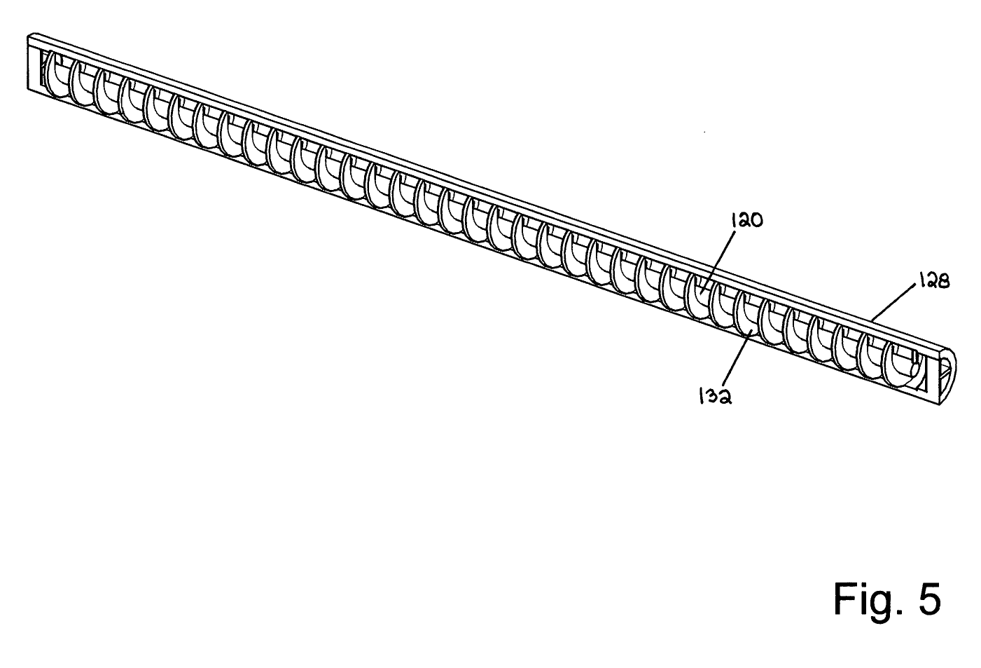

FIG. 6 is a longitudinal sectional view of one of the devices; and

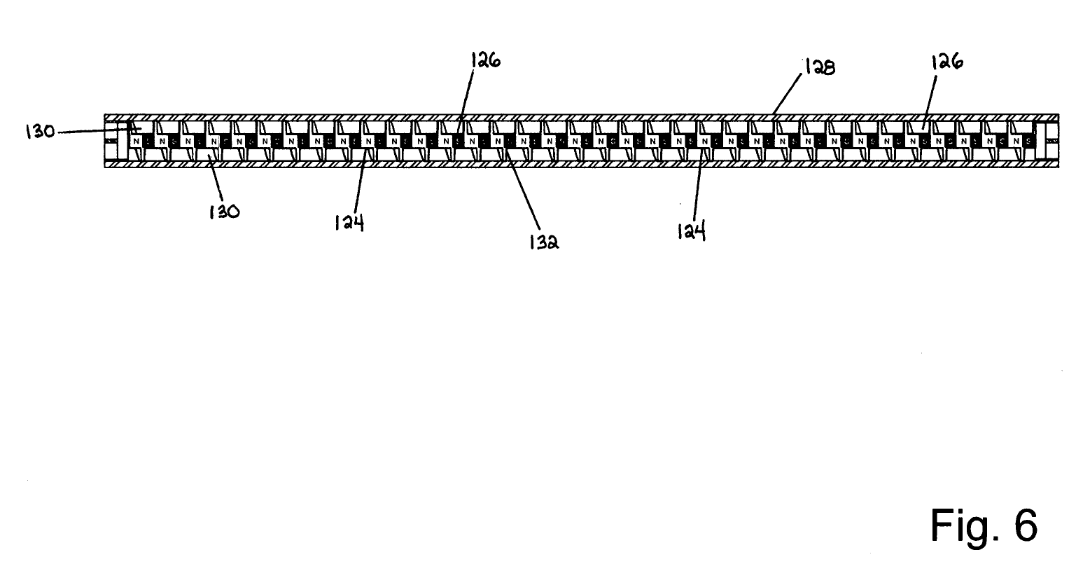

FIG. 7 is a perspective view of the cylindrical inner tube.

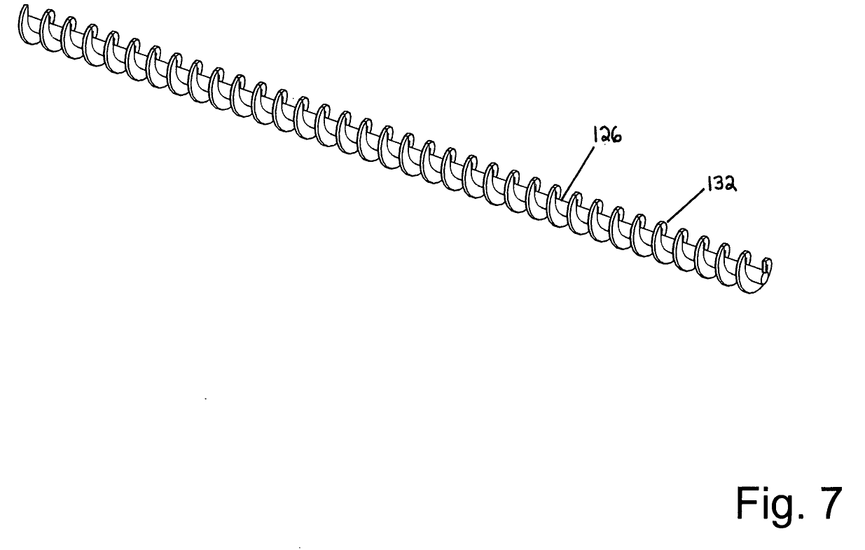

### DETAILED DESCRIPTION OF THE INVENTION

Referring to the drawings in greater detail and by reference characters thereto, there is illustrated a portable water purification device generally designated by reference numeral 10.

Portable water purification device 10 includes a housing 12. There is provided an inlet line 14 which is connected to a foot valve 16 which may be inserted into the body of water from which water is withdrawn for treatment.

Internally of housing 12 there is provided a pump 18 which is preferably a 12 volt DC pump. Pump 18 will transfer water through conduit 20 to various treatment stations which will include a first station comprising a screen filter 22. Downstream from screen filter 22 is a TDS probe and meter 24 to measure and display the total dissolved solids.

Subsequently, a pressure meter 26 will read the pressure in conduit 20 and display the same on the front of the water purification device 10.

Downstream from pressure meter 26 is a filter 28 which preferably is designed to filter out material above 0.9 microns. Such filters are known in the art and need not be discussed in detail herein.

Conduit 20 then leads to a further filter which is a combination KDF™ filter and activated charcoal. The KDF™ medium can be used to remove or reduce chlorine and water soluble heavy metals. It can filter scale, bacteria and algae. There are several different mixtures of the high purity granulated media which are known in the art. The media may be chosen according to the particular properties desired.

Following filter 30, there is provided a post filter pressure meter 32 and a TDS probe and meter 34.

Further downstream is a catalyzer generally designated by reference numeral 36 and which will be described in greater detail hereinbelow. Finally, the water is subjected to an ultraviolet treatment which is preferably a 12 volt DC powered UV.

Subsequently, there is provided a discharge conduit 40 for the treated water which is now suitable for consumption.

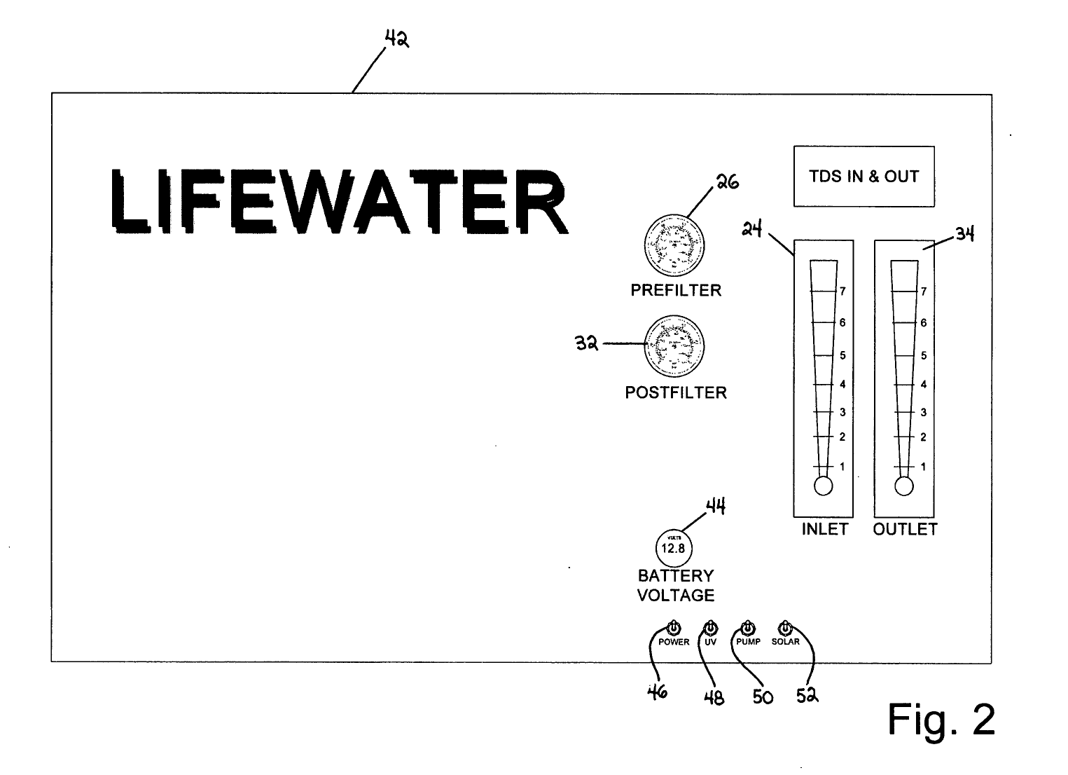

As may be seen in FIG. 2, a front panel 42, in addition to pressure meters 26, 32 and TDS meters 24, 34, may include a voltage meter 44.

Light indicators are provided for the various functions and in this regard, there may be provided a power light indicator 46, an ultraviolet light indicator 48, a pump light indicator 50 and a solar panel light indicator 52.

As shown in the electrical schematic, there is provided a battery 56 which is of the rechargeable type and which is operatively connected to a solar panel 58. It will be understood that in certain environments, a direct power connection may be utilized where available. The electrical arrangement includes a solar charge controller 60 and a relay 62.

Magnetic conditioner device or catalyzer 118 has an inner cylindrical tube 120. Inner cylindrical tube 120 is preferably formed of stainless steel. Mounted interiorly into cylindrical tube 120 are a plurality of magnets 122. Each magnet 122 has a north pole 124 and a south pole 126.

It will be noted that magnets 122 are magnetically aligned with a consistent north-south-north-south arrangement.

Surrounding inner cylindrical tube 120 is an outer cylindrical tube 128 which is concentric therewith. Formed between outer cylindrical tube 128 and inner cylindrical tube 120 is a fluid path generally designated by reference numeral 130.

Mounted in fluid path 130 are helical flights 132. It will be noted that helical flights 132 comprise a single helix which extends within fluid path 130 and is preferably secured to inner cylindrical tube 120. The result of the above arrangement is that the magnetic lines of flux of magnets 122 will intersect the water flow direction at an angle. It will of course be recognized that other arrangements with helical flights 132 may be utilized.

I claim:

1. A portable water purifier comprising:
a housing;
an inlet conduit;
a first filtration station;
a pump for pumping an aqueous fluid through said inlet conduit and through said first filtration station;
a second filtration station;
a magnetic treatment station wherein the magnetic lines of flux are angled with respect to the flow of the water;
a UV station; and
a discharge conduit.

2. The portable water purifier of claim 1 wherein said magnetic treatment station comprises means for creating magnetic lines of flux, said magnetic lines of flux being arranged so that flowing water cuts through said magnetic lines of flux at an angle.

3. The portable water purifier of claim 2 further including a third filtration station following said second filtration station.

4. The portable water purifier of claim 3 wherein said second filtration station comprises a high purity granulated medium designed for chlorine and algae removal.

5. The portable water purifier of claim 3 wherein said third filtration station comprises activated charcoal.

6. The portable water purifier of claim 5 further including an inlet flow meter.

7. The portable water purifier of claim 5 further including an outlet flow meter.

8. The portable water purifier of claim 5 further including a solar panel for powering said pump.

9. A method for purifying water comprising the steps of:
passing water to be treated through a first filtration station;
pumping said water through a second filtration station;
subsequently pumping said water through a magnetic treatment station wherein the magnetic lines of flux are angled with respect to the flow of the water; and
subjecting said water to an ultraviolet treatment.
